(19) United States
(12) Patent Application Publication
(10) Pub. No.: US 2024/0417508 A1
(43) Pub. Date: Dec. 19, 2024

(54) HALOGENATED POLYPHOSPHATE POLYOL AND PREPOLYMER AND PREPARATION METHOD THEREFOR, AS WELL AS POLYUREA ELASTOMER COMPOSITION AND POLYUREA ELASTOMER AND APPLICATION

(71) Applicants: CHINA PETROLEUM & CHEMICAL CORPORATION, Beijing (CN); SINOPEC Research Institute of Safety Engineering Co., Ltd., Qingdao, Shandong (CN)

(72) Inventors: Ke YANG, Qingdao, Shandong (CN); Qingli CHENG, Qingdao, Shandong (CN); Quanguo WANG, Qingdao, Shandong (CN); Hanhai DONG, Qingdao, Shandong (CN); Yongqian ZHEN, Qingdao, Shandong (CN); Rifeng ZHOU, Qingdao, Shandong (CN); Anfeng YU, Qingdao, Shandong (CN); Wenyi DANG, Qingdao, Shandong (CN); Zhe YANG, Qingdao, Shandong (CN)

(73) Assignees: CHINA PETROLEUM & CHEMICAL CORPORATION, Beijing (CN); SINOPEC Research Institute of Safety Engineering Co., Ltd., Qingdao, Shandong (CN)

(21) Appl. No.: 18/695,077

(22) PCT Filed: Sep. 26, 2022
(86) PCT No.: PCT/CN2022/121217

§ 371 Date: Mar. 25, 2024

(30) Foreign Application Priority Data
Sep. 29, 2021 (CN) 202111151784.4
Sep. 29, 2021 (CN) 202111151790.X
Sep. 29, 2021 (CN) 202111154238.6

(51) Int. Cl. C08G 18/67; C08G 18/10; C08G 18/32; C08G 18/38; C08G 18/50

(52) U.S. Cl. CPC C08G 18/67; C08G 18/10; C08G 18/324; C08G 18/3893; C08G 18/5024

(57) ABSTRACT

Described are a halogenated hydroxyl terminated polyphosphoester and a prepolymer and a preparation method therefor, as well as a polyurea elastomer composition and a polyurea elastomer and an application. A structural unit of the halogenated hydroxyl terminated polyphosphoester contains a halogenated phenyl phosphate group structure and one or more linking groups; the halogenated phenyl phosphate group has a structure represented by formula (1), and the linking group has a structure represented by formula (2); n is 1-10; R₁ is one or more of a substituted or unsubstituted benzene ring, —C(O)—R₂—C(O)—, and substituted or unsubstituted alkenylene; R₂ is selected from one or more of substituted or unsubstituted C₁-C₉ linear or branched alkylene, a substituted or unsubstituted benzene ring, and substituted or unsubstituted alkenylene; and X₁, X₂, X₃, X₄, and X₅ are the same or different, are each H and/or halogen, and are not H at the same time;

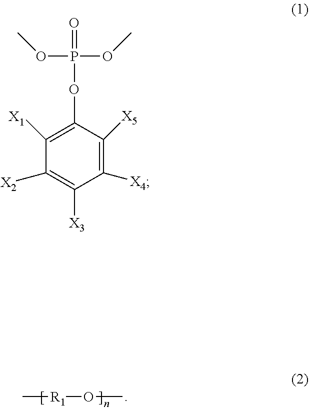

### CROSS-REFERENCE TO RELATED APPLICATIONS

The application claims benefits of the Chinese Application No. 202111151784.4, No. 202111151790.X and No. 202111154238.6, filed on Sep. 29, 2021, the contents of which are specifically and entirely incorporated herein by reference.

### FIELD

The present disclosure relates to the technical field of chemical materials, in particular to a halogenated hydroxyl terminated polyphosphoester and prepolymer and preparation method thereof, as well as polyurea elastomer composition and polyurea elastomer and application.

### BACKGROUND

The polyurea elastomer (PUA) is a polymer produced by reacting an isocyanate-terminated prepolymer (component A) with an amino compound component (R component). The PUA has excellent strength and elasticity, as well as excellent water resistance, chemical corrosion resistance and aging resistance, thus it is widely applied in the fields such as aerospace, military products and the petrochemical industry. However, PUA is a flammable organic polymer material, generally has a Limiting Oxygen Index (LOI) of 16-18%, and is extremely prone to burn when exposed to an open flame condition, so that the flame retardant property of PUA is an important factor restraining its development.

Scientific researchers have done a lot of work on the aspect of flame resistance and modification of PUA in recent years, and the flame resistance performance of PUA materials is generally improved by adding a large number of inorganic flame retardants (e.g., antimony trioxide, magnesium hydroxide and aluminum hydroxide) in the existing flame resistance and modification, but the inorganic flame retardants are used in a large amount and have poor dispersibility in the PUA materials, such that the mechanical properties of the materials are obviously reduced. Although the existing organic flame retardants (e.g., pentabromodiphenyl ether, triphenyl phosphate, and ammonium polyphosphate) have desirable dispersibility in the PUA material, they are easily exuded and lost, resulting in reduced flame retardance of the material and environmental pollution.

CN104130685A discloses a reaction type halogen-free flame-retardant spray polyurea elastomer coating and a preparation method thereof, wherein the industrial product phosphoric acid polyol is used, such as tri (dipropylene glycol) phosphite, N,N-bi (2-hydroxyethyl) diethyl aminomethyl phosphate and N,N-bi (2-hydroxyethyl) dimethyl aminomethyl phosphate. The existing phosphoric acid flame retardant is used in a large amount, and the dosage in the patent is 40%, so that the coating exhibits a desirable flame-retarding effect.

CN111499834A discloses a flame-retardant polyurea anti-explosion protective material and a preparation method thereof, wherein a composite flame retardant in use is a mixture of an additive type organic phosphate flame retardant and a reactive type halogen-free phosphorus-containing polyol, wherein the additive type organic phosphate flame retardant is one or two selected from the group consisting of dimethyl methyl phosphate, diethyl ethyl phosphate, dimethyl propyl phosphate, tri-ethyl phosphate, phthalic anhydride ester and tri (butoxyethyl) phosphate; the reactive type halogen-free phosphorus-containing polyol is one or two selected from the group consisting of tri (dipropylene glycol) phosphite, N,N-bi (2-hydroxyethyl) diethyl aminomethyl phosphate and N,N-bi (2-hydroxyethyl) dimethyl aminomethyl phosphate, and the composite flame retardant is used in a large amount but the flame-retarding effect is undesirable.

CN106117501A discloses a flame-retardant polyurea polyol and a preparation method thereof, wherein isocyanate, hydrazine hydrate and polyether polyol are used for synthesizing a polyurea polyol, which has better self-extinguishing property from fire, but fails to provide the application data in polyurea materials.

CN111218199A discloses a spraying polyurea waterproof and anticorrosive material with an intrinsic flame retardant structure and a preparation method thereof, a better degree of the flame-retarding effect is realized by using a composite flame retardant, wherein the composite flame retardant comprises 50-70% by mass of phthalic anhydride polyester polyol, 20-40% by mass of nano-SiO₂ and 1-3% by mass of a coupling agent, but the composite flame retardant is used in a large dosage.

CN111171687A discloses a flame-retardant polyurea coating and a preparation method thereof, wherein the flame retardant in use is a selenium-containing triazine macromolecular flame retardant compound, the flame retardance classification can reach V-0, but the mechanical properties of the material are less researched.

Therefore, the research and development of the flame-retardant polyurea material with high mechanical property and desirable flame resistance have extremely high investigation and application.

### SUMMARY

The present disclosure aims to overcome the defect of poor flame resistance of polyurea materials in the prior art and provide a halogenated hydroxyl terminated polyphosphoester and a prepolymer and a preparation method therefor, as well as a polyurea elastomer composition and a polyurea elastomer and an application, the polyurea elastomer has high mechanical property and desirable flame resistance, as well as desired comprehensive performance.

In order to achieve the above objects, the first aspect of the present disclosure provides a halogenated hydroxyl terminated polyphosphoester, wherein a structural unit of the halogenated hydroxyl terminated polyphosphoester comprises a halogenated phenyl phosphate group structure and one or more linking groups;
the halogenated phenyl phosphate group has a structure represented by formula (1);
the linking group has a structure represented by formula (2);

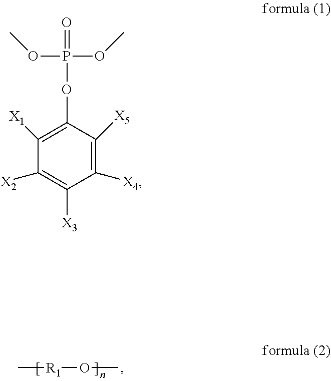

wherein n is an integer from 1 to 10, R₁ is one or more of a substituted or unsubstituted benzene ring, —C(O)—R₂—C(O)—, and substituted or unsubstituted alkenylene; R₂ is selected from one or more of substituted or unsubstituted C₁-C₉ linear or branched chain alkylene, a substituted or unsubstituted benzene ring, and substituted or unsubstituted alkenylene; X₁, X₂, X₃, X₄, and X₅ are the same or different, are each H and/or halogen, and are not H at the same time.

In a second aspect, the present disclosure provides a prepolymer comprising a structural unit provided by the aforementioned halogenated hydroxyl terminated polyphosphoester.

In a third aspect, the present disclosure provides a method for preparing the prepolymer comprising:
(D-1) contacting the aforementioned halogenated hydroxyl terminated polyphosphoester with polyether polyol to carry out a dehydration reaction to obtain an intermediate product;
(D-2) dontacting the intermediate product with isocyanate to perform a prepolymerization reaction to obtain a prepolymer.

In a fourth aspect, the present disclosure provides a halogenated polyphosphonic polyurea elastomer composition comprising component A and component B, wherein component A is the aforementioned prepolymer, and component B comprises an amino-terminated polyether, an organosilane and a chain extender.

The fifth aspect of the present disclosure provides a polyurea elastomer, wherein the polyurea elastomer has an oxygen index larger than or equal to 23%, a tensile strength larger than or equal to 18 MPa, and an elongation at break larger than or equal to 200%.

The sixth aspect of the present disclosure provides a method of using the aforementioned halogenated polyphosphonic polyurea elastomer in the fields of waterproofing, structural reinforcement, or damping and shock absorption of buildings.

Due to the technical scheme, the molecular chain structure of the halogenated polyphosphonic polyurea elastomer prepared by the present disclosure contains a halogenated hydroxyl terminated polyphosphoester flame-retardant structure, it has a high mechanical property and flame resistance, has a tensile strength more than or equal to 18 MPa, elongation at break more than or equal to 200%, does not need an additional flame retardant, and it has an oxygen index more than or equal to 23%.

### BRIEF DESCRIPTION OF THE DRAWINGS

FIG. 1 is an infrared spectrum of the halogenated polyphosphonic polyurea elastomer prepared in Example 1;

FIG. 2 is a Gel Permeation Chromatography (GPC) curves of the halogenated hydroxyl terminated polyphosphoester prepared in Example 1, Example 2 and Example 3 respectively;

FIG. 3 illustrates an infrared spectra of the halogenated hydroxyl terminated polyphosphoester prepared in Example 1, Example 2 and Example 3 respectively;

FIG. 4 shows a digital photograph of the halogenated polyphosphonic polyurea elastomer prepared in Example 3;

FIG. 5 shows the tensile curves of the halogenated polyphosphonic polyurea elastomers prepared in Examples 1-3;

FIG. 6 is a digital photograph showing the combustion comparison of the halogenated polyphosphonic polyurea elastomer prepared in Example 1 of the present disclosure with the polyurea elastomer prepared in Comparative Example 1.

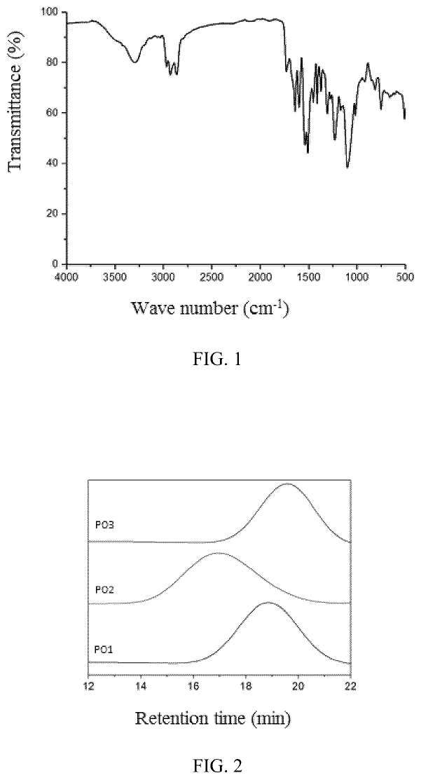

### THE DESCRIPTION OF REFERENCE SIGNS

1—Example 1;
2—Example 2;
3—Example 3;
S1—halogenated polyphosphonic polyurea elastomer prepared in Example 1 of the present disclosure;
DS1—polyurea elastomer prepared in Comparative Example 1 of the present disclosure.

### DETAILED DESCRIPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point value of the various ranges, and the individual point values may be combined with one another to produce one or more new numerical ranges, which should be deemed have been specifically disclosed herein.

In the first aspect, the present disclosure provides a halogenated hydroxyl terminated polyphosphoester, wherein a structural unit of the halogenated hydroxyl terminated polyphosphoester comprises a halogenated phenyl phosphate group structure and one or more linking groups;
the halogenated phenyl phosphate group has a structure represented by formula (1);
the linking group has a structure represented by formula (2);

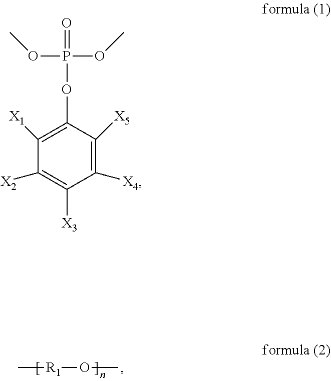

wherein n is an integer from 1 to 10, R₁ is one or more of a substituted or unsubstituted benzene ring, —C(O)—R₂—C(O)—, and substituted or unsubstituted alkenylene; R₂ is selected from one or more of substituted or unsubstituted C₁-C₉ linear or branched chain alkylene, a substituted or unsubstituted benzene ring, and substituted or unsubstituted alkenylene; X₁, X₂, X₃, X₄, and X₅ are the same or different, are each H and/or halogen, and are not H at the same time.

According to the present disclosure, the linking group has a structure represented by formula (3):

—O—R₃—O—C(O)—R₂—C(O)—O—R₃—O—, formula (3);
wherein R₂ is a C₂-C₆ alkylene containing a carbon-carbon double bond, preferably

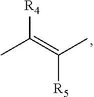

### or R₂ is

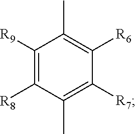

wherein R₄, R₅, R₆, R₇, R₈ and R₉ are the same or different, are each H, C₁-C₃ alkyl and/or halogen, and are not H at the same time;
wherein R₃ is selected from substituted or unsubstituted C₁-C₄ linear or branched chain alkylene.

According to the present disclosure, the linking group represented by formula (3) is preferably one or more selected from the structures represented by formula (4) or formula (5):

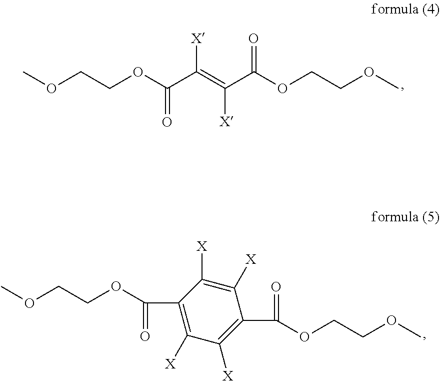

wherein X and X′ are the same or different, are each H and/or halogen atom, and are not H at the same time;

According to the present disclosure, it is preferable that X and X′ are each a bromine, chlorine, iodine or fluorine atom.

In the present disclosure, it shall be noted that when m=1, the present disclosure is a special case, the polymer becomes an oligomer under the polymerization conditions.

According to the present disclosure, the alkyl is preferably C₁-C₇ linear or branched chain alkyl, and more preferably C₁-C₆ linear or branched chain alkyl.

More preferably, according to the present disclosure, the halogenated hydroxyl terminated polyphosphoester comprises one or more structural units represented by formula (6) and formula (7);

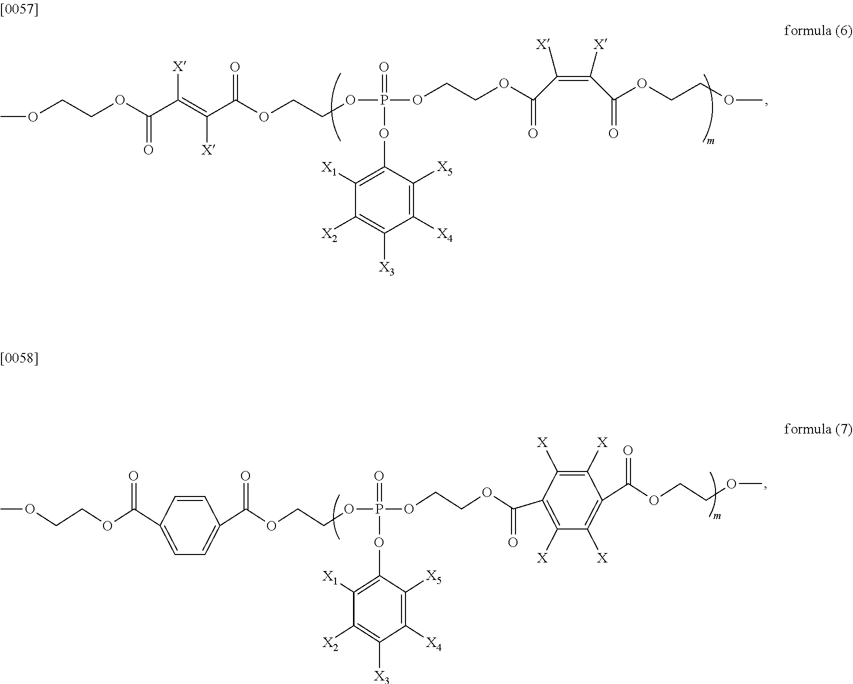

wherein X and X′ are the same or different, are each H and/or halogen atom, and are not H at the same time.

According to the present disclosure, it is preferable that X and X′ are each a bromine, chlorine, iodine, or fluorine atom.

According to the present disclosure, it is still further preferred that the halogenated hydroxyl terminated polyphosphoester comprises one or more structural units represented by formulae (8)-(12);

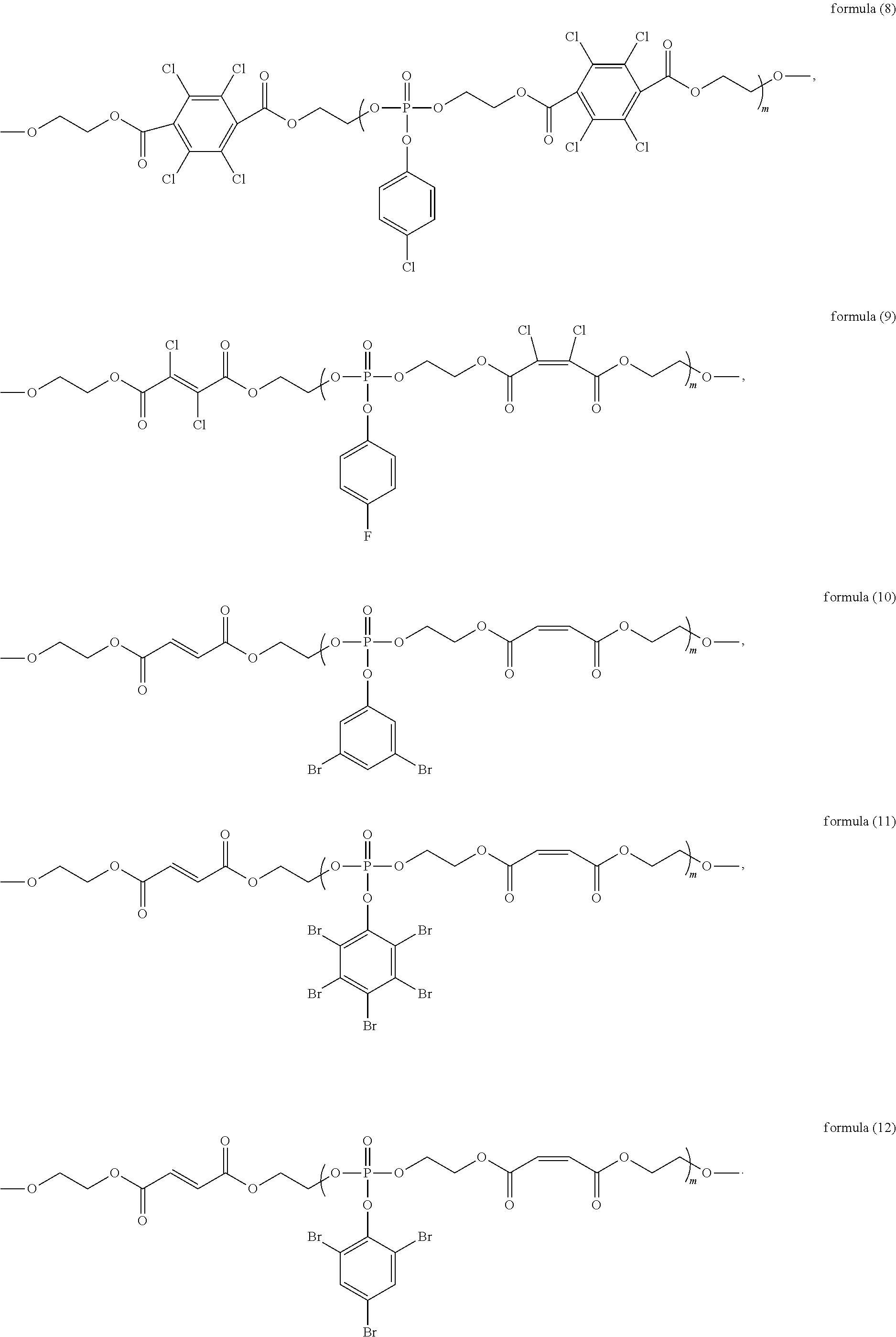

According to the present disclosure, the halogenated hydroxyl terminated polyphosphoester has a number average molecular weight within a range from 1,000 to 50,000 g/mol, preferably within a range from 1,000 to 48,000 g/mol, and a hydroxyl value within a range of 2.5-115 mg KOH/g, preferably within a range of 2.8-112 mg KOH/g.

According to a preferred embodiment of the present disclosure, a method for preparing a halogenated hydroxyl terminated polyphosphoester comprising:
(1-1) contacting phosphorus oxychloride POCl₃ with halogenated phenol shown by formula (13) in the presence of stannous octoate C₁₆H₃₀O₄Sn and dichloroethane C₂H₄Cl₂ to carry out a first reaction to obtain an intermediate product phenyl phosphoric acid represented by formula (14);

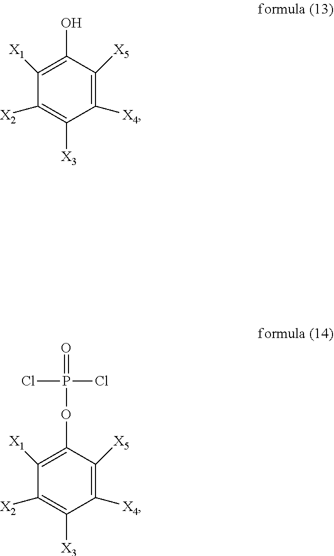

(1-2) dropwise adding a dichloroethane C₂H₄Cl₂ solution containing the phenyl phosphoric acid into a mixed solution containing dihydric alcohol represented by formula (15), dichloroethane and triethylamine C₆H₄N to perform a second reaction, then subjecting the reaction product to the washing, drying and filtering treatments to obtain a halogenated hydroxyl terminated polyphosphoester represented by formula (16);

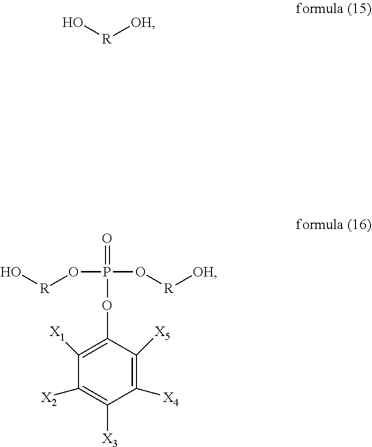

wherein R is one or more of the structures shown by

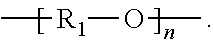

Wherein n is an integer from 1 to 10, R₁ is one or more of a substituted or unsubstituted benzene ring, —C(O)—R₂—C(O)—, and substituted or unsubstituted alkenylene; R₂ is selected from one or more of substituted or unsubstituted C₁-C₉ linear or branched chain alkylene, a substituted or unsubstituted benzene ring, and substituted or unsubstituted alkenylene; X₁, X₂, X₃, X₄, and X₅ are the same or different, are each H and/or halogen, and are not H at the same time.

According to the present disclosure, the linking group has a structure consistent with the expression of the structure shown by formula (3), the content is not repeatedly described herein.

According to a more preferred embodiment of the present disclosure, the method for preparing the halogenated hydroxyl terminated polyphosphoester comprising:
(1-1) contacting phosphorus oxychloride, dichloroethane, stannous octoate and halogenated phenol to carry out a first reaction to obtain an intermediate product phenyl phosphoric acid;

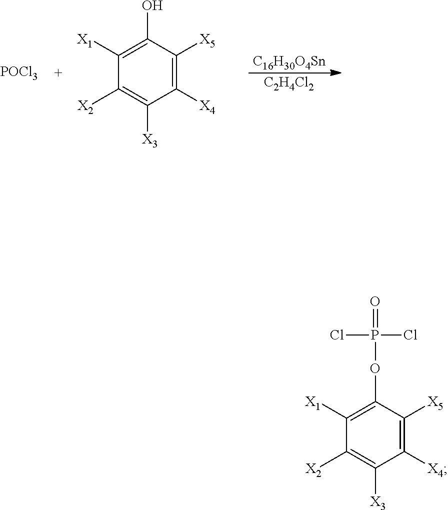

(1-2) dropwise adding the dichloroethane solution containing the phenyl phosphoric acid into a mixed solution containing dihydric alcohol, dichloroethane and triethylamine to perform a second reaction, then subjecting the reaction product to washing, drying and filtering treatments to obtain a halogenated hydroxyl terminated polyphosphoester.

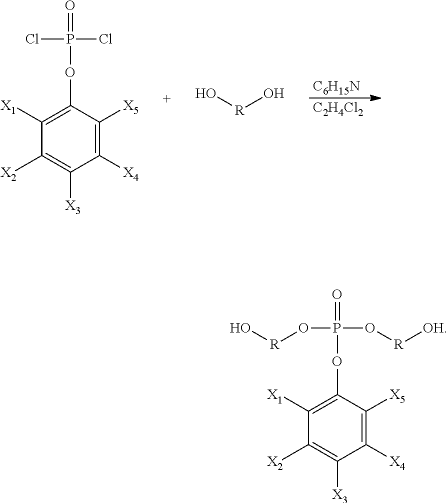

In the present disclosure, stannous octoate is a catalyst, phosphorus oxychloride and halogenated phenol are reactants, and dichloroethane is a solvent; phosphorus oxychloride and halogenated phenol are subjected to a first reaction to generate an intermediate product phenyl phosphoric acid; the phenyl phosphoric acid undergoes a second reaction with a diol to produce a halogenated hydroxyl terminated polyphosphoester (polyphosphate).

According to the present disclosure, the halogenated phenol is one or more selected from the group consisting of p-bromophenol, dibromophenol, tribromophenol, tetrabromophenol, pentabromophenol, trichlorophenol, pentachlorophenol, trifluorophenol and triiodophenol; preferably, the halogenated phenol is one or more selected from the group consisting of p-bromophenol, tribromophenol and pentabromophenol.

According to the present disclosure, the diol is one or more selected from the group consisting of ethylene glycol, propylene glycol, butylene glycol, pentylene glycol, hexylene glycol, heptylene glycol, octylene glycol, nonylene glycol, decylene glycol, ethylene glycol succinate polyol, ethylene glycol terephthalate polyol, ethylene glycol dichloromaleate maleate polyol and tetrachloroethylene glycol terephthalate polyol; preferably, the diol is one or more selected from the group consisting of ethylene glycol, butylene glycol, hexylene glycol, ethylene glycol succinate polyol, ethylene glycol terephthalate polyol, ethylene glycol dichloromaleate maleate polyol and tetrachloroethylene glycol terephthalate polyol.

According to the present disclosure, the molar ratio of the phosphorus oxychloride, the halophenol, the dihydric alcohol and the triethylamine is 1:(0.8-1.0):(2.0-2.2):(0.8-1.2).

According to the present disclosure, the stannous octoate is used in an amount of 0.1-0.5 wt. % based on the dosage of the halogenated phenol.

According to the present disclosure, the used amount of dichloroethane used in step (1-1) is not particularly defined, provided that it is sufficient to dissolve the reactants phosphorus oxychloride and halophenol; the used amount of dichloroethane in the dichloroethane solution containing the intermediate product in step (1-2) is not particularly limited, as long as it is sufficient to dissolve the intermediate product; and the used amount of dichloroethane in the mixed solution of the glycol, dichloroethane and triethylamine in step (1-2) is not particularly restricted, it is preferable in the present disclosure that the volume ratio of the used amount of the dichloroethane to the glycol is 1:(1-2).

According to the present disclosure, triethylamine is used as a pH conditioning agent, and the pH conditioning agent is used for maintaining the neutrality of the solution.

According to the present disclosure, the conditions of dropwise adding in the step (1-2) comprise: 1-2 drops/second, and in the present disclosure, the purpose of emphasizing the dropwise adding is to desirably control the heat release during the reaction.

According to the present disclosure, the conditions of the first reaction in step (1) include: the temperature is within a range of 0-20° C., and the time is 1-24h; preferably, the temperature is within a range of 0-20° C., and the time is 2-8h.

According to the present disclosure, the conditions of the second reaction in step (2) include: the temperature is within a range of 0-20° C., and the time is 1-24h; preferably, the temperature is within a range of 0-20° C., and the time is 2-16h.

According to a more preferred embodiment of the present disclosure, the method for preparing the halogenated hydroxyl terminated polyphosphoester comprising:
(1-1) adding phosphorus oxychloride, dichloroethane and stannous octoate into a reaction kettle, dropwise adding halogenated phenol at a rate of 1-2 drops/second under the condition of nitrogen gas and the temperature of 0-20° C., reacting for 2-8h, then draining the reaction solvent to obtain an intermediate product;
(1-2) adding dihydric alcohol, dichloroethane and triethylamine into a reaction kettle, and dropwise adding the dichloroethane solution of the intermediate product at a rate of 1-2 drops/second under the condition of nitrogen gas and the temperature of 0-20° C.; after the dropwise addition is finished, heating and refluxing for 8 h, adding 2 mol/L dilute hydrochloric acid solution and saturated sodium chloride aqueous solution and washing the dichloroethane solution to be neutral, drying with anhydrous magnesium sulfate, filtering and draining the solvent to prepare the halogenated hydroxyl terminated polyphosphoester.

In a second aspect, the present disclosure provides a prepolymer containing a structural unit provided by the aforementioned halogenated hydroxyl terminated polyphosphoester.

According to the present disclosure, the prepolymer has a number average molecular weight within a range from 1,500 to 50,000 g/mol.

According to the present disclosure, the prepolymer is obtained through a pre-polymerization reaction of halogenated hydroxyl terminated polyphosphoester with polyether polyol and isocyanate; preferably, the prepolymer has an NCO content within a range of 10-20 wt. %, preferably within a range of 13-20 wt. %.

According to the present disclosure, it is preferable that the isocyanate is contained in an amount of 20-70 wt. %, the polyether polyol is contained in an amount of 20-70 wt. %, and the halogenated polycarbonate polyol is contained in an amount of 5-20 wt. %, based on the total weight of the prepolymer; preferably, the isocyanate is contained in an amount of 25-65 wt. %, the polyether polyol is contained in an amount of 25-55 wt. %, and the halogenated polycarbonate polyol is contained in an amount of 5-20 wt. %, based on the total weight of component A; more preferably, the isocyanate is contained in an amount of 30-60 wt. %, the polyether polyol is contained in an amount of 25-30 wt. %, and the halogenated polycarbonate polyol is contained in an amount of 10-20 wt. %, based on the total weight of the prepolymer.

In a third aspect, the present disclosure provides a method for preparing a prepolymer comprising:
(D-1) contacting the aforementioned halogenated hydroxyl terminated polyphosphoester with polyether polyol to carry out a dehydration reaction to obtain an intermediate product;
(D-2) contacting the intermediate product with isocyanate to perform a pre-polymerization reaction to obtain a prepolymer.

The present inventors have discovered that: on one hand, the modified polyphosphoester containing the halogen functional groups is used for preparing the halogenated hydroxyl terminated polyphosphoester, the halogenated hydroxyl terminated polyphosphoester has the dehydration and flame-retardant effect of the phosphoester, and exhibits the flame-retardant property of halogen; preferably, on the other hand, the chain segment hydroxyl of the halogenated hydroxyl terminated polyphosphoester maintains the pre-polymerization activity with isocyanate, so that the halogenated polyphosphonic polyurea elastomer prepared through the pre-polymerization reaction of the halogenated hydroxyl terminated polyphosphoester, the polyether polyol and the isocyanate can keep the desirable mechanical property and improved flame resistance.

According to the present disclosure, the dehydration reaction conditions comprise a temperature within the range of 60-120° C. and a time within the range of 0.5-1.5h. Preferably, the halogenated hydroxyl terminated polyphosphoester and the polyether polyol are subjected to the dehydration treatment in advance, and are dehydrated under the vacuum condition and the temperature of 60-120° C. for 0.5-1.5 hours, then cooled to 40-60° C. to be ready for subsequent defoaming reaction with isocyanate.

According to the present disclosure, the pre-polymerization reaction conditions comprise a temperature within the range of 40-90° C., and a time within the range of 1-3h; preferably, a temperature within the range of 60-80° C., and a time within the range of 1-2h.

According to the present disclosure, the isocyanate is used in an amount of 20-70 wt. %, the polyether polyol is used in an amount of 20-70 wt. %, and the halogenated hydroxyl terminated polyphosphoester is used in an amount of 5-20 wt. %, based on the total weight of the prepolymer; preferably, the isocyanate is contained in an amount of 25-65 wt. %, the polyether polyol is contained in an amount of 25-55 wt. %, and the halogenated polycarbonate polyol is contained in an amount of 5-20 wt. %, based on the total weight of component A; more preferably, the isocyanate is contained in an amount of 30-60 wt. %, the polyether polyol is contained in an amount of 25-30 wt. %, and the halogenated polycarbonate polyol is contained in an amount of 10-20 wt. %, based on the total weight of the prepolymer.

In a fourth aspect, the present disclosure provides a halogenated polyphosphonic polyurea elastomer composition comprising component A and component B, wherein component A is the aforementioned prepolymer, and component B comprises an amino-terminated polyether, an organosilane and a chain extender.

According to the present disclosure, the ratio of component A to component B calculated based on the isocyanate index is (1-1.2):1, preferably (1-1.05):1.

According to the present disclosure, it shall be noted that the term “isocyanate index” refers to the molar ratio of isocyanato to amino groups.

According to the present disclosure, the halogenated polyphosphonic polyurea elastomer comprises an isocyanate structural unit represented by formula (17) provided by the isocyanate and a halogenated hydroxyl terminated polyphosphoester structural unit provided by the aforementioned halogenated hydroxyl terminated polyphosphoester;

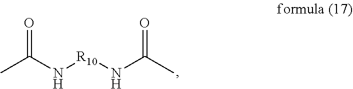

wherein R₁₀ is an aromatic or aliphatic isocyanate residue.

According to the present disclosure, the isocyanate is contained in an amount of 20-70 wt. %, the polyether polyol is contained in an amount of 20-70 wt. %, and the halogenated hydroxyl terminated polyphosphoester is contained in an amount of 5-20 wt. %, based on the total weight of component A; preferably, the isocyanate is used in an amount of 25-65 wt. %, the polyether polyol is used in an amount of 25-55 wt. %, and the halogenated polycarbonate polyol is used in an amount of 5-20 wt. %, based on the total weight of component A; more preferably, the isocyanate is contained in an amount of 30-60 wt. %, the polyether polyol is contained in an amount of 25-30 wt. %, and the halogenated polycarbonate polyol is contained in an amount of 10-20 wt. %, based on the total weight of the prepolymer.

According to the present disclosure, the amino-terminated polyether is contained in an amount of 18-80 wt. %, the organosilane is contained in an amount of 0.2-2 wt. %, and the chain extender is contained in an amount of 20-35 wt. %, based on the total weight of component B; preferably, the amino-terminated polyether is contained in an amount of 24-65 wt. %, the organosilane is contained in an amount of 0.2-1 wt. %, and the chain extender is contained in an amount of 20-30 wt. %, based on the total weight of component B.

According to the present disclosure, the isocyanate is one or more selected from the group consisting of toluene diisocyanate, diphenylmethane-4,4′-diisocyanate, polymethylene polyphenyl polyisocyanate, liquefied diphenylmethane diisocyanate, xylylene diisocyanate, isophorone diisocyanate, hexamethylene diisocyanate, cyclohexane dimethylene diisocyanate and 4,4′-dicyclohexylmethane diisocyanate.

According to the present disclosure, the polyether polyol is one or more selected from the group consisting of polytetrahydrofuran glycol, polyoxypropylene ether polyol, polyoxyethylene polyol, hydroxyl-terminated polybutadiene, polypropylene glycol, polyethylene glycol, fatty acid triglyceride, polycaprolactone polyol, polycarbonate diol and 1,4-butanediol.

According to the present disclosure, the amino-terminated polyether is one or more selected from the group consisting of the amino-terminated polyethers T5000, T3000, T403, D4000, D2000, D400 and D230.

According to the present disclosure, the chain extender is one or more selected from the group consisting of diethyl toluene diamine, dimethyl thiotoluene diamine, N,N-dialkylmethyl diamine, N,N-dialkylphenylene diamine, and isophorone diamine.

According to the present disclosure, the organosilane is one or more selected from the group consisting of 3-aminopropyl trimethoxysilane, 3-aminopropyl triethoxysilane, 3-(2,3-glycidoxy) propyl trimethoxysilane, 3-(methacryloyloxy) propyl trimethoxysilane, mercaptopropyl trimethoxysilane and 3-mercaptopropyl triethoxysilane; preferably, the organosilane is one or more selected from the group consisting of 3-aminopropyl trimethoxysilane, 3-aminopropyl triethoxysilane and 3-(2,3-glycidoxy) propyl trimethoxysilane. In the present disclosure, the organic silane is selected to improve the wettability of the material interface. In addition, the organosilane is added into component B, instead of being added during the preparation process of component A, in order to improve the interfacial properties of the material with the substrate.

The fifth aspect of the present disclosure provides a polyurea elastomer, wherein the polyurea elastomer has an oxygen index larger than or equal to 23%, a tensile strength larger than or equal to 18 MPa, and an elongation at break larger than or equal to 200%; preferably, the polyurea elastomer has an oxygen index within a range of 23-28%, tensile strength within a range of 18-30 MPa, and elongation at break within a range of 280-400%.

The present disclosure also provides a method for preparing a halogenated polyphosphonic polyurea elastomer comprising:
(1) contacting halogenated hydroxyl terminated polyphosphoester, polyether polyol and an optional diluent with isocyanate to perform a prepolymerization reaction to obtain component A;
(2) contacting the component A and the component B according to an isocyanate index of (1-1.2): 1 to carry out a polymerization reaction, wherein component B comprises an amino-terminated polyether, an organosilane and a chain extender.

According to the present disclosure, it is preferable that component A further comprises a diluent, and the diluent is used in an amount of 0-15 wt. %, more preferably 2-12 wt. %, based on the total weight of component A.

According to the present disclosure, the isocyanate is used in an amount of 20-70 wt. %, the polyether polyol is used in an amount of 20-70 wt. %, the halogenated polycarbonate polyol is used in an amount of 5-20 wt. %, and the diluent is used in an amount of 0-15 wt. %, based on the total weight of component A; preferably, the isocyanate is used in an amount of 25-65 wt. %, the polyether polyol is used in an amount of 25-55 wt. %, the halogenated polycarbonate polyol is used in an amount of 5-20 wt. %, and the diluent is used in an amount of 2-12 wt. %, based on the total weight of component A; more preferably, the isocyanate is used in an amount of 30-60 wt. %, the polyether polyol is used in an amount of 25-30 wt. %, the halogenated polycarbonate polyol is used in an amount of 10-20 wt. %, and the diluent is used in an amount of 2-12 wt. %, based on the total weight of component A. In the present disclosure, when the used amount of each component is defined within the foregoing range, it produces an advantage that the material maintains desirable mechanical properties and flame resistance.

According to the present disclosure, component A is a prepolymer, and in the present disclosure, component A has a number average molecular weight within a range from 1,000 to 50,000 g/mol; the NCO content of component A is within a range of 10-20 wt. %, preferably within a range of 12-20 wt. %.

According to the present disclosure, the diluent is one or more selected from the group consisting of cresyl-diphenyl phosphate, 2-ethylhexyl diphenyl ester, propylene carbonate, ethyl carbonate, dibutyl phthalate, 2-chloroethyl ester and acetone.

According to the present disclosure, component B further comprises a filler and an additive agent.

According to the present disclosure, the filler is one or more selected from the group consisting of bentonite, montmorillonite, calcium carbonate, silica, carbon nanotubes, graphene, carbon fibers, glass fibers, aluminum hydroxide, magnesium hydroxide and cellulose; preferably, the filler is one or more selected from the group consisting of montmorillonite, silica, carbon nanotubes, aluminum hydroxide and magnesium hydroxide.

According to the present disclosure, the additive agent is one or more selected from the group consisting of a coloring agent, ultraviolet light absorbent, flatting agent, defoaming agent, diluent and dispersant; wherein the colorant is white paste and/or black paste manufactured by the Beijing Xinnuoan Powder Polymer Co., Ltd.; the ultraviolet light absorbent is an anti-ultraviolet agent HM; the flatting agent is a BYK leveling agent; the defoaming agent is a BYK defoaming agent; the dispersant is a BYK dispersant; the diluent is propylene carbonate.

According to the present disclosure, the amino-terminated polyether is used in an amount of 18-80 wt. %, the chain extender is used in an amount of 20-35 wt. %, and the organosilane is used in an amount of 0.2-2 wt. %, based on the total weight of component B; preferably, the amino-terminated polyether is used in an amount of 24-65 wt. %, the chain extender is used in an amount of 20-30 wt. %, and the organosilane is used in an amount of 0.2-1 wt. %, based on the total weight of component B.

According to the present disclosure, the filler is used in an amount of 1-30 wt. %, and the additive agent is used in an amount of 5-15 wt. %, based on the total weight of component B; preferably, the filler is used in an amount of 5-30 wt. % and the additive agent is used in an amount of 5-15 wt. %, based on the total weight of component B.

In the present disclosure, the used amount of each component is limited within the aforementioned range, the polyurea material prepared with the method has the advantages of more excellent mechanical properties and flame resistance.

According to the present disclosure, the ratio of component A to component B in terms of the isocyanate index is (1-1.2): 1, preferably (1-1.05): 1.

According to the present disclosure, the isocyanate, halogenated hydroxyl terminated polyphosphoester, polyether polyol, optional diluent, amino-terminated polyether, chain extender and organosilane correspond to those described above and will not be repeatedly described herein.

According to the present disclosure, the pre-polymerization reaction conditions in step (1) comprise a temperature within the range of 40-90° C., and a time within the range of 1-3h; preferably, the temperature is within the range of 60-80° C. and the time is within the range of 1-2h.

According to the present disclosure, the halogenated hydroxyl terminated polyphosphoester and the polyether polyol are subjected to the dehydration treatment in advance, and are dehydrated under the vacuum condition and the temperature of 60-120° C. for 0.5-1.5 hours. In the present disclosure, after the defoaming reaction is completed, the temperature is lowered, preferably to 40-60° C. to be ready for subsequent defoaming reaction with isocyanate.

According to the present disclosure, the contacting conditions in step (2) preferably include: the stirring speed is within a range of 1,000-2,000 rpm, the temperature is within a range of 25-60° C., and the time is 30-120 min; more preferably, the stirring rate is within a range of 1,000-1,500 rpm, the temperature is within a range of 30-60° C., and the time is 60-80 min.

According to the present disclosure, the polymerization conditions in step (2) preferably comprise a temperature within the range of 60-75° C., that is, the polymerization reaction is carried out while mixing; more preferably, the temperature is within the range of 65-70° C. In the present disclosure, a two-component spray gun is used for spraying, the amino-terminated polyether participates in the mixing and curing reaction of component A and component B, wherein the component A and the component B are mixed and cured in a manner similar to the AB glue.

According to a preferred embodiment of the present disclosure, the method for preparing the halogenated polyphosphonic polyurea elastomer comprising:
(1) Preparation of component A:
adding polyether (ester) polyol and halogenated hydroxyl terminated polyphosphoester into a reaction kettle, dehydrating under the vacuum condition and the temperature of 60-120° C. for 0.5-1.5 h, then cooling to 40-60° C., adding the corresponding proportion of isocyanate into the reaction kettle, heating to 60-80° C., performing heat preservation and reaction for 1-2 h, defoaming and cooling to obtain the component A, wherein the content of NCO % is within a range of 12-20%; the used amount of the isocyanate is within the range of 30-60 wt. %, the used amount of the polyether (ester) polyol is within the range of 25-30 wt. %, and the used amount of the halogenated hydroxyl terminated polyphosphoester is within the range of 10-20 wt. %, based on the total weight of component A;
(2) Preparation of component B:
pouring the following raw materials according to the percentage by mass into a reaction kettle: 24-65% of amino-terminated polyether, 20-30% of chain extender, 5-30% of filler, 0.2-1% of organosilane and 5-15% of other additive agents, heating to 30-60° C., and stirring for 60-80 min under the condition of nitrogen gas to obtain the component B;
(3) Preparation of polyurea material:
spraying the component A and component B according to the isocyanate index of 1-1.05 to obtain the polyurea material.

In a sixth aspect, the present disclosure provides a method of using the aforementioned halogenated polyphosphonic polyurea elastomer in the fields of waterproofing, structural reinforcement, or damping and shock absorption of buildings.

According to the present disclosure, the building waterproof paint comprises building roof waterproof paint and reservoir waterproof paint.

According to the present disclosure, the structural reinforcement comprises a building repair coating and a wall reinforcing coating.

According to the present disclosure, the damping and shock absorption comprises shock absorption paint and anti-noise paint.

The present disclosure will be described in detail below with reference to examples.

In the following examples and comparative examples:
(1) Performance test

Number average molecular weight test: the normal temperature Gel Permeation Chromatography (GPC) test was performed by using the GPC-2414 type gel permeation chromatograph manufactured by the Waters Corporation, the measuring temperature was 30° C., tetrahydrofuran was used as a mobile phase solvent, the liquid phase flow rate was 1.0 ml/min, and polystyrene standard sample was adopted to calibrate the molecular weight;

Hydroxyl value test: measured by using the standard phthalic anhydride-pyridine reflux method.
(2) Source of raw materials

The raw materials diphenylmethane-4,4′-diisocyanate and toluene diisocyanate were commercially available products with the product names MDI-50 and TDI-80 manufactured by the Wanhua Chemical Company;

The raw material of the amino-terminated polyether was the commercially available product with the brand numbers D2000, T5000 and D400 manufactured by Huntsman LLC.;

The raw materials polyoxypropylene ether polyol, polytetrahydrofuran diol, polycaprolactone diol, halogenated phenol, stannous octoate, small molecular diol, phosphorus oxychloride and silane were the commercially available products manufactured by the Macklin Chemical Reagent Incorporation.

Unless otherwise specified, % represents % by weight or wt. % in the following examples and comparative examples.

### Example 1

The example served to illustrate the halogenated polyphosphonic polyurea elastomer prepared with the method of the present disclosure.
(1) Preparation of the halogenated hydroxyl terminated polyphosphoester:
1) 0.1 mol of phosphorus oxychloride, 60 mL of dichloroethane and 0.1 g of stannous octoate were added into a three-neck flask, 40 ml of dichloroethane solution of 0.1 mol pentabromophenol was dropwise added at a rate of 1-2 drops/second under the condition of nitrogen gas and the temperature of 0° C., after reaction for 4 hours, the reaction solvent was drained to obtain an intermediate product P1;
2) 0.22 mol of ethylene glycol succinate, 100 ml of dichloroethane and 0.1 mol of triethylamine were added into a three-neck flask, 50 mL of dichloroethane solution of the intermediate product P1 was dropwise added at a rate of 1-2 drops/second under the condition of nitrogen gas and the temperature of 0° C.;
3) after the dropwise adding was completed, the temperature was raised and the mixture was refluxed for 8 hours, 2 mol/L of dilute hydrochloric acid solution and saturated sodium chloride aqueous solution were added to wash the mixture to be neutral, the mixture was dried by anhydrous magnesium sulfate, filtered and the solvent was drained to obtain halogenated hydroxyl terminated polyphosphoester PO1.

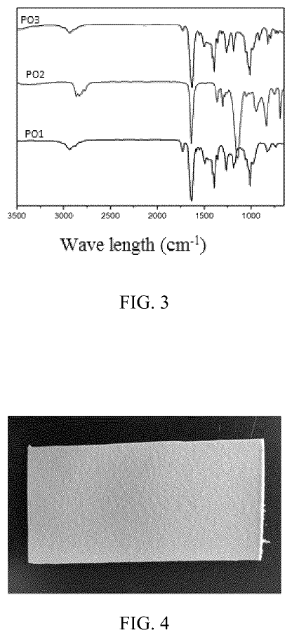

FIG. 3 illustrated an infrared spectrogram of the halogenated hydroxyl terminated polyphosphoester prepared in Example 1; the infrared spectrogram of the obtained halogenated polycarbonate polyol PO1 was illustrated in FIG. 3, as can be seen from FIG. 3, the halogenated hydroxyl terminated polyphosphoester of Example 1 contained an infrared absorption peak of phosphate (1257 cm⁻¹), an infrared absorption peak of double bond (1726 cm⁻¹) and an absorption peak of benzene ring (1624 cm⁻¹).

The GPC spectrogram of the obtained halogenated hydroxyl terminated polyphosphoester PO1 was shown in FIG. 2, as can be seen from FIG. 2, the halogenated hydroxyl terminated polyphosphoester of Example 1 was a high molecular weight polymer with unimodal distribution, the halogenated hydroxyl terminated polyphosphoester PO1 had a number average molecular weight of 3,000 g/mol and a hydroxyl value of 36 mg KOH/g. By combining the infrared spectrogram with the raw materials and the reaction conditions, it can be determined that the halogenated hydroxyl terminated polyphosphoester PO1 was represented by the following structural formula:

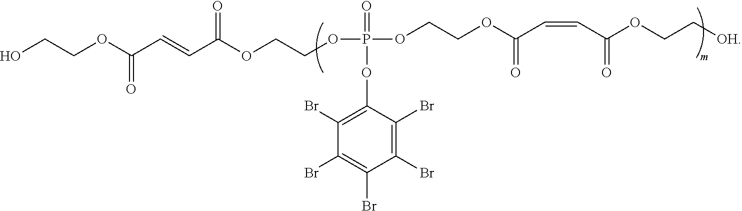

(2) Preparation of component A: polytetrahydrofuran diol and halogenated hydroxyl terminated polyphosphoester were added into a reaction kettle, then dehydrated at 100° C. for 1 h, diphenylmethane-4,4′-diisocyanate was then added at 60° C., and reacted at 80° C. for 1.5 h, the reactants were uniformly stirred and cooled, ethyl carbonate was further added, the materials were discharged to obtain prepolymer A1 which was regarded as the component A, wherein the NCO % was 13%.

The structural unit of obtained prepolymer A1 was as follows:

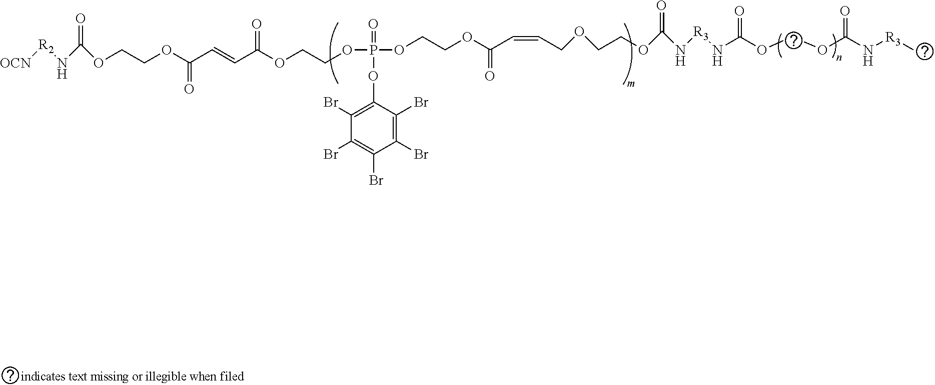

R₃=

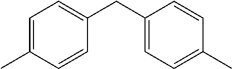

In addition, the prepolymer A1 had a number average molecular weight of 4,500;
Component A comprising: 36 wt. % of polytetrahydrofuran diol (PTMG-1000), 20 wt. % of halogenated polycarbonate PO1, 42 wt. % of diphenylmethane 4,4′-diisocyanate and 2 wt. % of ethyl carbonate.
(3) Preparation of component B: the amino-terminated polyether D2000, diethyl toluene diamine, 3-(2,3-epoxypropoxy) propyl trimethoxy silane, silica and aluminum hydroxide were added into a reaction kettle, heated to 40° C. under the condition of nitrogen gas, stirred for 80 min, and the materials were discharged to obtain the component B;
Component B comprising: 55 wt. % of amino-terminated polyether (D2000), 30 wt. % of diethyl toluene diamine, 0.2 wt. % of 3-(2,3-epoxypropoxy) propyl trimethoxy silane, 8 wt. % of aluminum hydroxide, 1.8 wt. % of silica, 5 wt. % of other additive agents (in particular, 1 wt. % of color paste manufactured by the Beijing Xinnuoan Powder Polymer Co., Ltd., 2 wt. % of ultraviolet light absorber HM, 2 wt. % of BYK defoamer).
(4) Preparation of halogenated polyphosphonic polyurea elastomers.

The two-component high-pressure spray gun was used for spraying the component A and component B according to an isocyanate index of 1.1 onto the surface of a polytetrafluoroethylene plate at the temperature of 70° C., and subjected to fast curing and molding, wherein the spraying thickness was 2 mm, so that the halogenated polyphosphonic polyurea elastomer S1 was obtained.

### Example 2

The example served to illustrate the halogenated polyphosphonic polyurea elastomer prepared with the method of the present disclosure.
(1) Preparation of the halogenated hydroxyl terminated polyphosphoester:
1) 0.1 mol of phosphorus oxychloride, 60 ml of dichloroethane and 0.1 g of stannous octoate were added into a three-neck flask, 40 ml of dichloroethane solution of 0.1 mol p-chlorophenol was dropwise added at a rate of 1-2 drops/second under the condition of nitrogen gas and the temperature of 0° C., after reaction for 4 hours, the reaction solvent was drained to obtain an intermediate product P2;
2) 0.25 mol of 2,3,5,6-tetrachloro-1,4-dicarboxylic acid bis(2-hydroxyethyl) ester, 100 ml of dichloroethane and 0.1 mol of triethylamine were added into a three-neck flask, 50 ml of dichloroethane solution of the intermediate product P2 was dropwise added at a rate of 1-2 drops/second under the condition of nitrogen gas and the temperature of 0° C.;
3) After the dropwise adding was completed, the temperature was raised and the mixture was refluxed for 8 hours, 2 mol/L of dilute hydrochloric acid solution and saturated sodium chloride aqueous solution were added to wash the mixture to be neutral, the mixture was dried by anhydrous magnesium sulfate, filtered and the solvent was drained to obtain halogenated hydroxyl terminated polyphosphoester PO2.

FIG. 3 illustrated an infrared spectrogram of the halogenated hydroxyl terminated polyphosphoester prepared in Example 2; as can be seen from FIG. 3: the halogenated hydroxyl terminated polyphosphoester of Example 2 contained an infrared absorption peak of phosphate (1250 cm⁻¹) and an absorption peak of the benzene ring (1630 cm⁻¹).

The GPC spectrogram of the obtained halogenated hydroxyl terminated polyphosphoester PO2 was shown in FIG. 2, as can be seen from FIG. 2, the halogenated hydroxyl terminated polyphosphoester of Example 2 was a high molecular weight polymer with unimodal distribution, the halogenated hydroxyl terminated polyphosphoester PO12 had a number average molecular weight of 48,000 and a hydroxyl value of 2.8 mg KOH/g. By combining the infrared spectrogram with the raw materials and the reaction conditions, it can be determined that the halogenated hydroxyl terminated polyphosphoester PO2 was represented by the following structural formula:

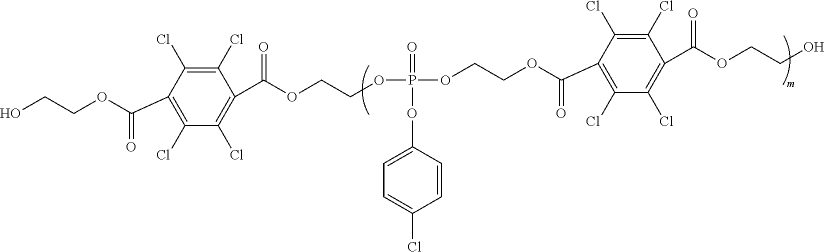

(2) Preparation of component A: polyoxypropylene polyether polyol and halogenated polycarbonate polyol were into a reaction kettle, then dehydrated at 100° C. for 1 h, 4,4′-dicyclohexylmethane diisocyanate was then added at the temperature of 40° C., and reacted at 70° C. for 2 h, the reactants were uniformly stirred and cooled, dibutyl phthalate was further added, the materials were discharged to obtain prepolymer A2 which was regarded as the component A, wherein the NCO % was 13%.

The structural unit of obtained prepolymer A2 was as follows:

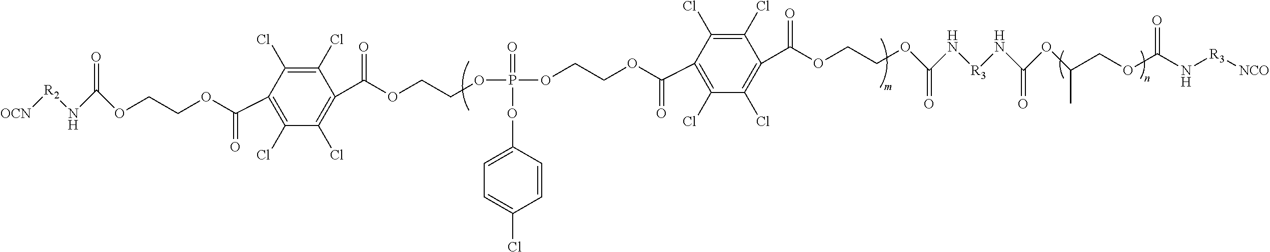

R₃=

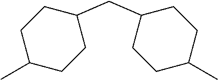

In addition, the prepolymer A2 had a number average molecular weight of 50,000 g/mol;
Component A comprising: 54 wt. % of polyoxypropylene polyether polyol (8200), 16 wt. % of halogenated polyphosphate PO2, 20 wt. % of dicyclohexylmethane diisocyanate and 10 wt. % of dibutyl phthalate.
(3) Preparation of component B: amino-terminated polyether, isophorone diamine, mercaptopropyl trimethoxy silane, magnesium hydroxide, montmorillonite, carbon nano tube and other additive agents were added into a reaction kettle, heated to 30° C. under the condition of nitrogen gas, stirred for 60 min, and the materials were discharged to obtain a component B.
Component B comprised the following ingredients: 31 wt. % of amino-terminated polyether (D400), 30 weight percent of amino-terminated polyether (T403), 20 wt. % of isophorone diamine, 1 wt. % of mercaptopropyl trimethoxy silane, 10 wt. % of magnesium hydroxide, 2.5 wt. % of montmorillonite, 0.5 wt. % of carbon nano tube and 5 wt. % of other additive agents (in particular, 1 wt. % of color paste manufactured by the Beijing Xinnuoan Powder Polymer Co., Ltd., 2 wt. % of ultraviolet light absorber HM, 2 wt. % of BYK defoamer).
(4) Preparation of halogenated polyphosphonic polyurea elastomers.

The two-component high-pressure spray gun was used for spraying the component A and component B according to an isocyanate index of 1.0 onto the surface of a polytetrafluoroethylene plate at the temperature of 70° C., and subjected to fast curing and molding, wherein the spraying thickness was 2 mm, so that the halogenated polyphosphonic polyurea elastomer S2 was obtained.

### Example 3

The example served to illustrate the halogenated polyphosphonic polyurea elastomer prepared with the method of the present disclosure.
(1) Preparation of the halogenated hydroxyl terminated polyphosphoester:
1) 0.1 mol of phosphorus oxychloride, 60 ml of dichloroethane and 0.1 g of stannous octoate were added into a three-neck flask, 40 ml of dichloroethane solution of 0.1 mol p-fluorophenol was dropwise added at a rate of 1-2 drops/second under the condition of nitrogen gas and the temperature of 0° C., after reaction for 4 hours, the reaction solvent was drained to obtain an intermediate product P3;
2) 0.28 mol of dichloromaleic acid bis(2-hydroxyethyl) ester, 100 ml of dichloroethane and 0.1 mol of triethylamine were added into a three-neck flask, 50 ml of dichloroethane solution of the intermediate product P3 was dropwise added at a rate of 1-2 drops/second under the condition of nitrogen gas and the temperature of 0° C.;
3) After the dropwise adding was completed, the temperature was raised and the mixture was refluxed for 8 hours, 2 mol/L of dilute hydrochloric acid solution and saturated sodium chloride aqueous solution were added to wash the mixture to be neutral, the mixture was dried by anhydrous magnesium sulfate, filtered and the solvent was drained to obtain halogenated hydroxyl terminated polyphosphoester PO3.

In addition, FIG. 3 illustrated an infrared spectrogram of the halogenated hydroxyl terminated polyphosphoester prepared in Example 3; as can be seen from FIG. 3, the infrared spectrogram of the obtained halogenated polycarbonate polyol PO3 was illustrated in FIG. 3, the halogenated hydroxyl terminated polyphosphoester of Example 3 contained an infrared absorption peak of phosphate (1254 cm⁻¹), an infrared absorption peak of double bond (1726 cm⁻¹) and an absorption peak of the benzene ring (1631 cm⁻¹).

The GPC spectrogram of the obtained halogenated hydroxyl terminated polyphosphoester PO3 was shown in FIG. 2, as can be seen from FIG. 2, the halogenated hydroxyl terminated polyphosphoester of Example 3 was a high molecular weight polymer with unimodal distribution, the halogenated hydroxyl terminated polyphosphoester PO1 had a number average molecular weight of 1,000 and a hydroxyl value of 111 mg KOH/g. By combining the infrared spectrogram with the raw materials and the reaction conditions, it can be determined that the halogenated hydroxyl terminated polyphosphoester PO3 was represented by the following structural formula:

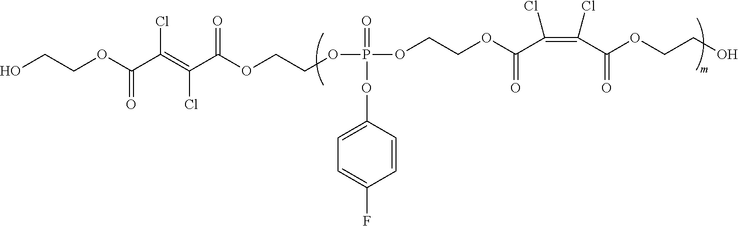

Wherein FIG. 4 showed a digital photograph schematic diagram of the halogenated polyphosphonic polyurea elastomer prepared in Example 3; the product halogenated polyphosphonic polyurea elastomer was a coating, which was prepared into a sheet to facilitate testing and spraying on a flat plate; as can be seen from FIG. 4: the halogenated polyphosphonic polyurea elastomer of Example 3 was a smooth flat sheet-like material in appearance.
(2) Preparation of component A: polyoxypropylene polyether polyol and halogenated hydroxyl terminated polyphosphoester were added into a reaction kettle, dehydrated at the temperature of 100° C. for 1h, isophorone diisocyanate was then added at the temperature of 40° C., and reacted at 60° C. for 2 h, the reactants were uniformly stirred and cooled, the materials were discharged to obtain prepolymer A3 which was regarded as the component A, wherein the NCO % was 20%.

The structural unit of obtained prepolymer A3 was as follows:

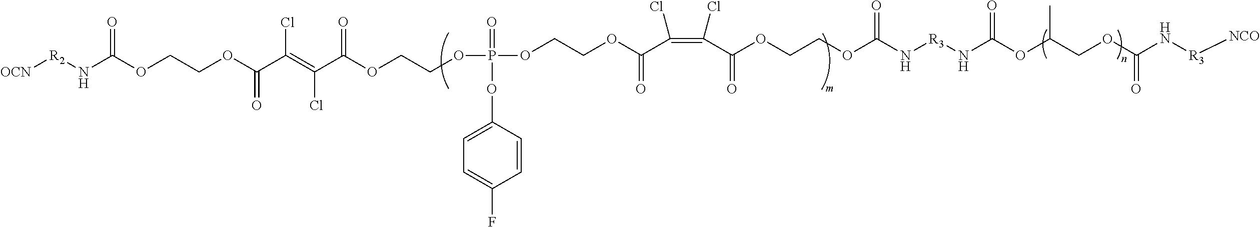

R₃=

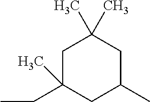

In addition, the prepolymer A1 had a number average molecular weight of 1,800 g/mol;
Component A comprising: 10 wt. % of polycaprolactone diol (D560), 15 wt. % of polyethylene glycol (1000), 10 wt. % of halogenated polyphosphates, 55 wt. % of isophorone diisocyanate.
(3) Preparation of component B: the amino-terminated polyether, dimethyl-thio-toluenediamine, 3-aminopropyl trimethoxy silane, magnesium hydroxide, aluminum hydroxide and other additive agents were added into a reaction kettle, heated to 60° C. under the condition of nitrogen gas, stirred for 30 min, and the materials were discharged to obtain a component B.
Component B comprising: 20 wt. % of amino-terminated polyether (D2000), 14 wt. % of amino-terminated polyether (T5000), 20 wt. % of dimethylthio toluene diamine, 1 wt. % of 3-aminopropyl trimethoxysilane, 10 wt. % of magnesium hydroxide, 20 wt. % of aluminum hydroxide, 15 wt. % of other additive agents (in particular, 1 wt. % of color paste manufactured by the Beijing Xinnuoan Powder Polymer Co., Ltd., 2 wt. % of ultraviolet light absorber HM, 2 wt. % of BYK defoamer, 10 wt. % of diluent propylene carbonate).
(4) Preparation of halogenated polyphosphonic polyurea elastomers.

The two-component high-pressure spray gun was used for spraying the component A and component B according to an isocyanate index of 1.2 onto the surface of a polytetrafluoroethylene plate at the temperature of 60° C., and subjected to fast curing and molding, wherein the spraying thickness was 2 mm, so that the halogenated polyphosphonic polyurea elastomer S3 was obtained.

### Example 4

The example served to illustrate the halogenated polyphosphonic polyurea elastomer prepared with the method of the present disclosure.
(1) Preparation of the halogenated hydroxyl terminated polyphosphoester:
1) 0.1 mol of phosphorus oxychloride, 60 ml of dichloroethane and 0.1 g of stannous octoate were added into a three-neck flask, 40 ml of dichloroethane solution of 0.1 mol 2,4,6-tribromophenol was dropwise added at a rate of 1-2 drops/second under the condition of nitrogen gas and the temperature of 0° C., after reaction for 4 hours, the reaction solvent was drained to obtain an intermediate product P5;
2) 0.22 mol of maleic acid bis(2-hydroxyethyl) ester, 100 ml of dichloroethane and 0.1 mol of triethylamine were added into a three-neck flask, 50 ml of dichloroethane solution of the intermediate product P5 was dropwise added at a rate of 1-2 drops/second under the condition of nitrogen gas and the temperature of 0° C.;
3) After the dropwise adding was completed, the temperature was raised and the mixture was refluxed for 8 hours, 2 mol/L of dilute hydrochloric acid solution and saturated sodium chloride aqueous solution were added to wash the mixture to be neutral, the mixture was dried by anhydrous magnesium sulfate, filtered and the solvent was drained to obtain halogenated hydroxyl terminated polyphosphoester PO4.

The resulting halogenated hydroxyl terminated polyphosphoester PO4 had a number average molecular weight of 2,000 and a hydroxyl value of 55 mg KOH/g. By combining the infrared spectrogram with the raw materials and the reaction conditions, it can be determined that the halogenated hydroxyl terminated polyphosphoester PO4 was represented by the following structural formula:

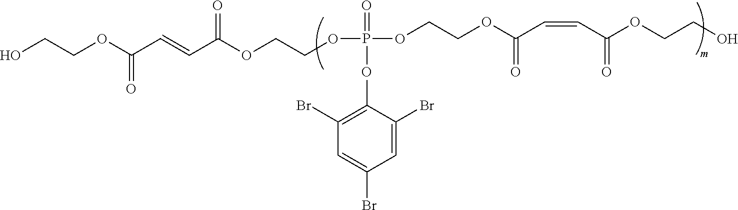

(2) Preparation of component A: polyoxypropylene polyether polyol and halogenated polycarbonate polyol were added into a reaction kettle, then dehydrated at 100° C. for 1h, toluene diisocyanate was then added at the temperature of 60° C., and reacted at 90° C. for 1.0h, the reactants were uniformly stirred and cooled, ethyl carbonate was further added, the materials were discharged to obtain prepolymer A4 which was regarded as the component A, wherein the NCO % was 18%.

In addition, the structural unit of obtained prepolymer A4 was as follows:

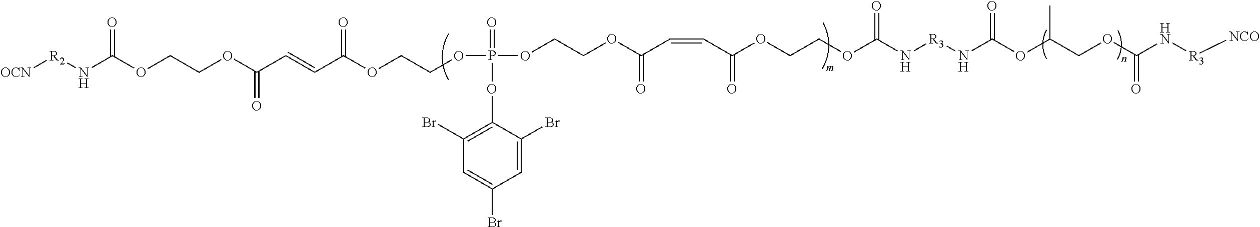

R₃=

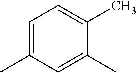

Moreover, the prepolymer A4 had a number average molecular weight of 3,000 g/mol.
Component A comprises: 28 wt. % of polyoxypropylene polyether polyol (1000), 10 wt. % of halogenated hydroxyl terminated polyphosphoester, 62 wt. % of xylylene isocyanate.
(3) Preparation of component B: the amino-terminated polyether, diethyl toluene diamine, 3-(2,3-epoxypropoxy) propyl trimethoxy silane, montmorillonite, calcium carbonate, glass fiber, aluminum hydroxide and other additive agents were added into a reaction kettle, heated to 60° C. under the condition of nitrogen gas, stirred for 60 min, and the materials were discharged to obtain the component B;
Component B comprises the following ingredients: 40 wt. % of amino-terminated polyether (D2000), 9 wt. % of amino-terminated polyether (T5000), 25 wt. % of diethyl toluene diamine, 1 wt. % of 3-(2,3-glycidoxy) propyl trimethoxysilane, 2 wt. % of montmorillonite, 2 wt. % of calcium carbonate, 1 wt. % of glass fiber, 10 wt. % of aluminum hydroxide, 10 wt. % of other additive agents (in particular, 1 wt. % of color paste manufactured by the Beijing Xinnuoan Powder Polymer Co., Ltd., 2 wt. % of ultraviolet light absorber HM, 2 wt. % of BYK defoamer, 5 wt. % of diluent propylene carbonate).
(4) Preparation of halogenated polyphosphonic polyurea elastomers

The two-component high-pressure spray gun was used for spraying the component A and component B according to an isocyanate index of 1.1 onto the surface of a polytetrafluoroethylene plate at the temperature of 65° C., and subjected to fast curing and molding, wherein the spraying thickness was 2 mm, so that the halogenated polyphosphonic polyurea elastomer S4 was obtained.

### Example 5

The example served to illustrate the halogenated polyphosphonic polyurea elastomer prepared with the method of the present disclosure.
(1) Preparation of the halogenated hydroxyl terminated polyphosphoester:
1) 0.1 mol of phosphorus oxychloride, 60 ml of dichloroethane and 0.1 g of stannous octoate were into a three-neck flask, 40 ml of dichloroethane solution of 0.1 mol 3,5-dibromophenol dichloroethane was dropwise added at a rate of 1-2 drops/second under the condition of nitrogen gas and the temperature of 0° C., after reaction for 4 hours, the reaction solvent was drained to obtain an intermediate product P4;
2) 0.25 mol of maleic acid bis(2-hydroxyethyl) ester, 100 ml of dichloroethane and 0.1 mol of triethylamine were added into a three-neck flask, 50 ml of dichloroethane solution of the intermediate product P4 was dropwise added at a rate of 1-2 drops/second under the condition of nitrogen gas and the temperature of 0° C.;
3) After the dropwise adding was completed, the temperature was raised and the mixture was refluxed for 8 hours, 2 mol/L of dilute hydrochloric acid solution and saturated sodium chloride aqueous solution were added to wash the mixture to be neutral, the mixture was dried by anhydrous magnesium sulfate, filtered and the solvent was drained to obtain halogenated hydroxyl terminated polyphosphoester PO5.

The resulting halogenated hydroxyl terminated polyphosphoester PO5 had a number average molecular weight of 1,000 and a hydroxyl value of 112 mg KOH/g. By combining the infrared spectrogram with the raw materials and the reaction conditions, it can be determined that the halogenated hydroxyl terminated polyphosphoester PO5 was represented by the following structural formula:

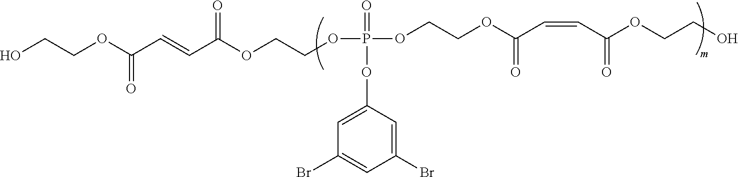

(2) Preparation of component A: hydroxyl-terminated polybutadiene and halogenated polycarbonate polyol were added into a reaction kettle, then dehydrated at 100° C. for 1h, toluene diisocyanate was then added at 40° C., and reacted at 80° C. for 2 h, the reactants were uniformly stirred and cooled, ethyl carbonate was further added, the materials were discharged to obtain prepolymer A5 which was regarded as the component A, wherein the NCO % was 10%.

In addition, the structural unit of obtained prepolymer A5 was as follows:

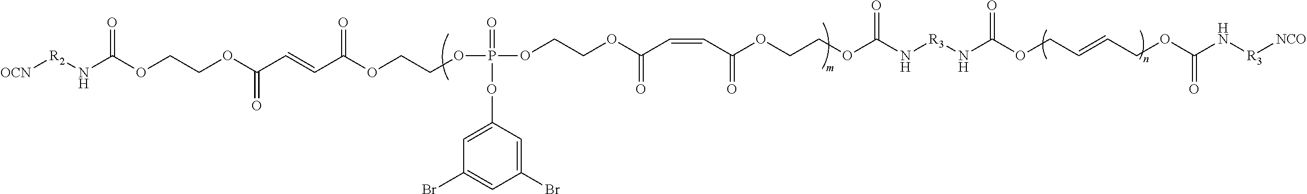

R₃=

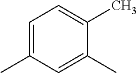

Moreover, the prepolymer A5 had a number average molecular weight of 1,600 g/mol.
Component A comprises: 67 wt. % of hydroxyl-terminated polybutadiene (2000), 5 wt. % of halogenated hydroxyl terminated polyphosphoester, 28 wt. % of toluene diisocyanate.
(3) Preparation of component B: amino-terminated polyether, N,N-dialkyl phenylenediamine, 3-(methacryloyloxy) propyl trimethoxy silane, carbon nano tubes, carbon fibers, aluminum hydroxide and other additive agents were added into a reaction kettle, heated to 60° C. under the condition of nitrogen gas, stirred for 60 min, and the materials were discharged to obtain the component B;
Component B comprising: 40 wt. % of amino-terminated polyether (D2000), 9 wt. % of amino-terminated polyether (T3000), 25 wt. % of N,N-dialkyl phenylene diamine, 1 wt. % of 3-(methacryloyloxy) propyl trimethoxysilane, 2 wt. % of carbon nanotubes, 3 wt. % of carbon fibers, 15 wt. % of aluminum hydroxide, 5 wt. % of other additive agents (in particular, 1 wt. % of color paste manufactured by the Beijing Xinnuoan Powder Polymer Co., Ltd., 2 wt. % of ultraviolet light absorber HM, 2 wt. % of BYK defoamer).
(4) Preparation of halogenated polyphosphonic polyurea elastomers.

The two-component high-pressure spray gun was used for spraying the component A and component B according to an isocyanate index of 1.1 onto the surface of a polytetrafluoroethylene plate at the temperature of 65° C., and subjected to fast curing and molding, wherein the spraying thickness was 2 mm, so that the halogenated polyphosphonic polyurea elastomer S1 was obtained.

### Example 6

The polyurea elastomer was prepared according to the same method as that in Example 1, except that:

In step (2) of preparing the component A, the used amounts of components were as follows:

6 wt. % of polytetrahydrofuran diol (PTMG-1000), 50 wt. % of halogenated polycarbonate PO1, 22 wt. % of diphenylmethane 4,4′-diisocyanate and 20 wt. % of ethyl carbonate.

As a result, the halogenated polyphosphonic polyurea elastomer S6 was obtained.

### Example 7

The polyurea elastomer was prepared according to the same method as that in Example 1, except that:

In step (3) of preparing the component B:
the following raw materials were poured into a reaction kettle: 5 wt. % of amino-terminated polyether (D2000), 80 wt. % of diethyl toluene diamine, 0.2 wt. % of 3-(2,3-glycidoxy) propyl trimethoxysilane, 8 wt. % of aluminum hydroxide, 1.8 wt. % of silica, 5 wt. % of other additive agents;

As a result, the halogenated polyphosphonic polyurea elastomer S7 was obtained.

### Comparative Example 1

The polyurea elastomer was prepared according to the same method as that in Example 1, except that the halogenated hydroxyl terminated polyphosphoester PO1 was not added.

As a result, the polyurea elastomer DS1 was prepared.

### Comparative Example 2

The polyurea elastomer was prepared according to the same method as that in Example 2, except that the halogenated hydroxyl terminated polyphosphoester PO2 was not added.

As a result, the polyurea elastomer DS2 was prepared.

### Comparative Example 3

The polyurea elastomer was prepared according to the same method as that in Example 3, except that the halogenated hydroxyl terminated polyphosphoester PO3 was not added.

As a result, the polyurea elastomer DS3 was prepared.

### Comparative Example 4

The polyurea elastomer was prepared according to the same method as that in Example 4, except that the halogenated hydroxyl terminated polyphosphoester PO4 was not added.

As a result, the polyurea elastomer DS4 was prepared.

### Comparative Example 5

The polyurea elastomer was prepared according to the same method as that in Example 5, except that the halogenated hydroxyl terminated polyphosphoester PO5 was not added.

As a result, the polyurea elastomer DS5 was prepared.

### Comparative Example 6

The polyurea elastomer was prepared according to the same method as that in Example 1, except that the “halogenated hydroxyl terminated polyphosphoester” was replaced with a flame retardant additive “tri(chloroisopropyl) phosphate” during the process of preparing the component A.

As a result, the polyurea elastomer DS6 was prepared.

### Test Example

Tests of tensile properties (tensile strength and elongation at break) were performed according to the Chinese National Standard GB/T528-2009;

The test of an oxygen index was performed according to the Chinese National Standard GB/T2406-2009;

Test of the precipitate content: the test sample was put into an ethanol solution, heated and refluxed for 48 hours, the sample was taken out for drying, and the mass change of the sample was measured.

The properties of the polyurea elastomers prepared in Examples 1-7 and Comparative Examples 1-6 were tested using the aforementioned method. The results were shown in Table 1.

TABLE 1

| | Tensile | Elongation | Oxygen | Precipitate |
|---|---|---|---|---|
| | strength | at break | index | content |
| Samples | (MPa) | (%) | (%) | (%) |
| S1 | 28 | 300 | 28 | <1 |
| S2 | 25 | 320 | 24 | <1 |
| S3 | 30 | 328 | 26 | <1 |
| S4 | 24 | 280 | 25 | <1 |
| S5 | 18 | 400 | 23 | <1 |
| S6 | 14 | 235 | 24 | <1 |
| S7 | 19 | 186 | 24 | <1 |
| DS1 | 24 | 350 | 15 | <1 |
| DS2 | 24 | 320 | 16 | <1 |
| DS3 | 28 | 140 | 15 | <1 |
| DS4 | 14 | 310 | 15 | <1 |
| DS5 | 22 | 230 | 18 | <1 |
| DS6 | 8 | 96 | 13 | <1 |

Note:
the precipitate content refers to the total content of the small-molecule polymer.

As can be seen from the results in Table 1, the halogenated polyphosphonic polyurea elastomers prepared with the preparation method of the present disclosure in Examples 1-5 may have a high oxygen index on the basis of exhibiting desirable mechanical properties.

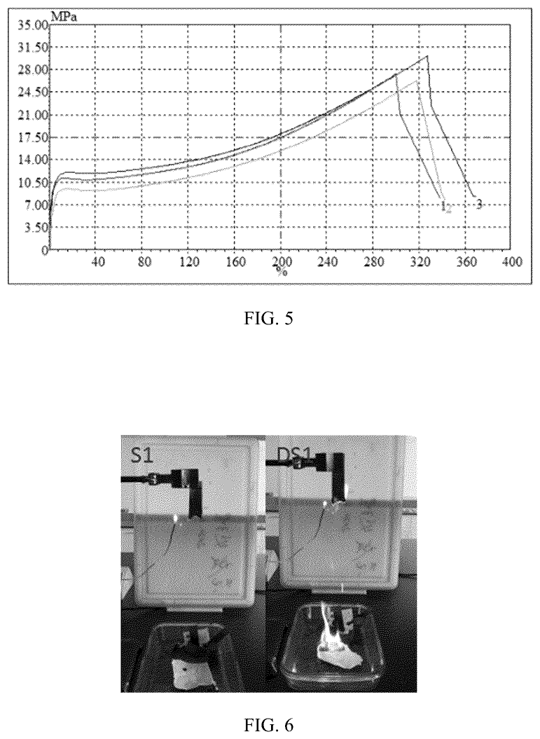

In addition, FIG. 5 is a schematic diagram showing the tensile property curves of the halogenated polyphosphonic polyurea elastomers prepared in Examples 1-3; as can be seen from FIG. 5: the tensile strength of the materials of Examples 1-3 is greater than or equal to 25 MPa.

FIG. 6 is showing the combustion comparison of the halogenated polyphosphonic polyurea elastomer prepared in Example 1 of the present disclosure with the polyurea elastomer prepared in Comparative Example 1; as illustrated by FIG. 6, the halogenated polyphosphonic polyurea elastomer S1 prepared in Example 1 of the present disclosure does not burn and exhibits the flame resistance; while the polyurea elastomer DS1 prepared in Comparative Example 1 is burned, indicating that it lacks flame resistance.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1-18. (canceled)

19. A halogenated polyphosphate polyol, wherein a structural unit of the halogenated polyphosphate polyol comprises a halogenated phenyl phosphate group structure and one or more linking groups;
the halogenated phenyl phosphate group has a structure represented by formula (1);
the linking group has a structure represented by formula (2): 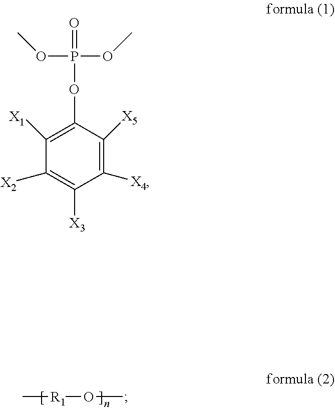
wherein n is an integer from 1 to 10, R₁ is one or more of a substituted or unsubstituted benzene ring, —C(O)—R₂—C(O)—, and substituted or unsubstituted alkenylene; R₂ is selected from one or more of substituted or unsubstituted C₁-C₉ linear or branched chain alkylene, a substituted or unsubstituted benzene ring, and substituted or unsubstituted alkenylene; X₁, X₂, X₃, X₄, and X₅ are the same or different, are each H and/or halogen, and are not H at the same time.

20. The polyol according to claim 19, wherein the linking group has a structure represented by formula (3):
—O—R₃—O—C(O)—R₂—C(O)—O—R₃—O—, formula (3),
wherein R₂ is a C₂-C₆ alkylene containing a carbon-carbon double bond, R₃ is selected from substituted or unsubstituted C₁-C₄ linear or branched chain alkylene.

21. The polyol according to claim 20, wherein R₂ is 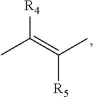
or R₂ is 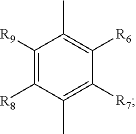
wherein R₄, R₅, R₆, R₇, R₈ and R₉ are the same or different, are each H, C₁-C₃ alkyl and/or halogen, and are not H at the same time.

22. The polyol according to claim 20, wherein the linking group represented by formula (3) is one or more selected from of the structures represented by formula (4) or formula (5): 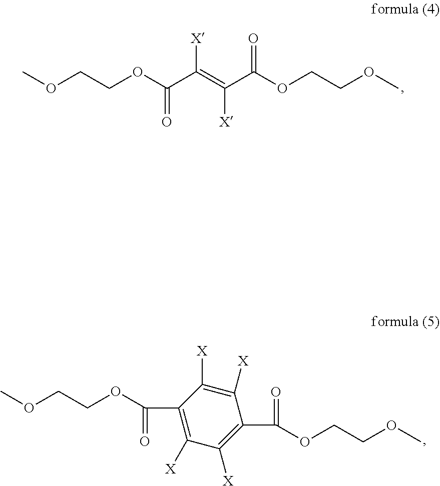
wherein X and X′ are the same or different, are each H and/or halogen atom, and are not H at the same time.

23. The polyol according to claim 22, wherein X and X′ are each a bromine, chlorine, iodine or fluorine atom.

24. The polyol according to claim 19, wherein the halogenated hydroxyl terminated polyphosphoester comprises one or more structural units represented by formula (6) and formula (7):

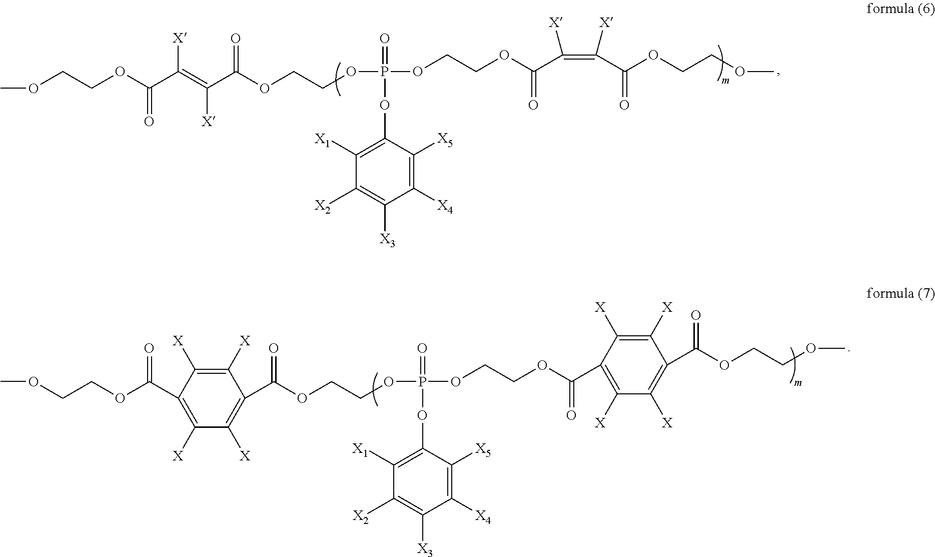

25. The polyol according to claim 24, wherein the halogenated hydroxyl terminated polyphosphoester comprises one or more structural units represented by formulae (8)-(12):

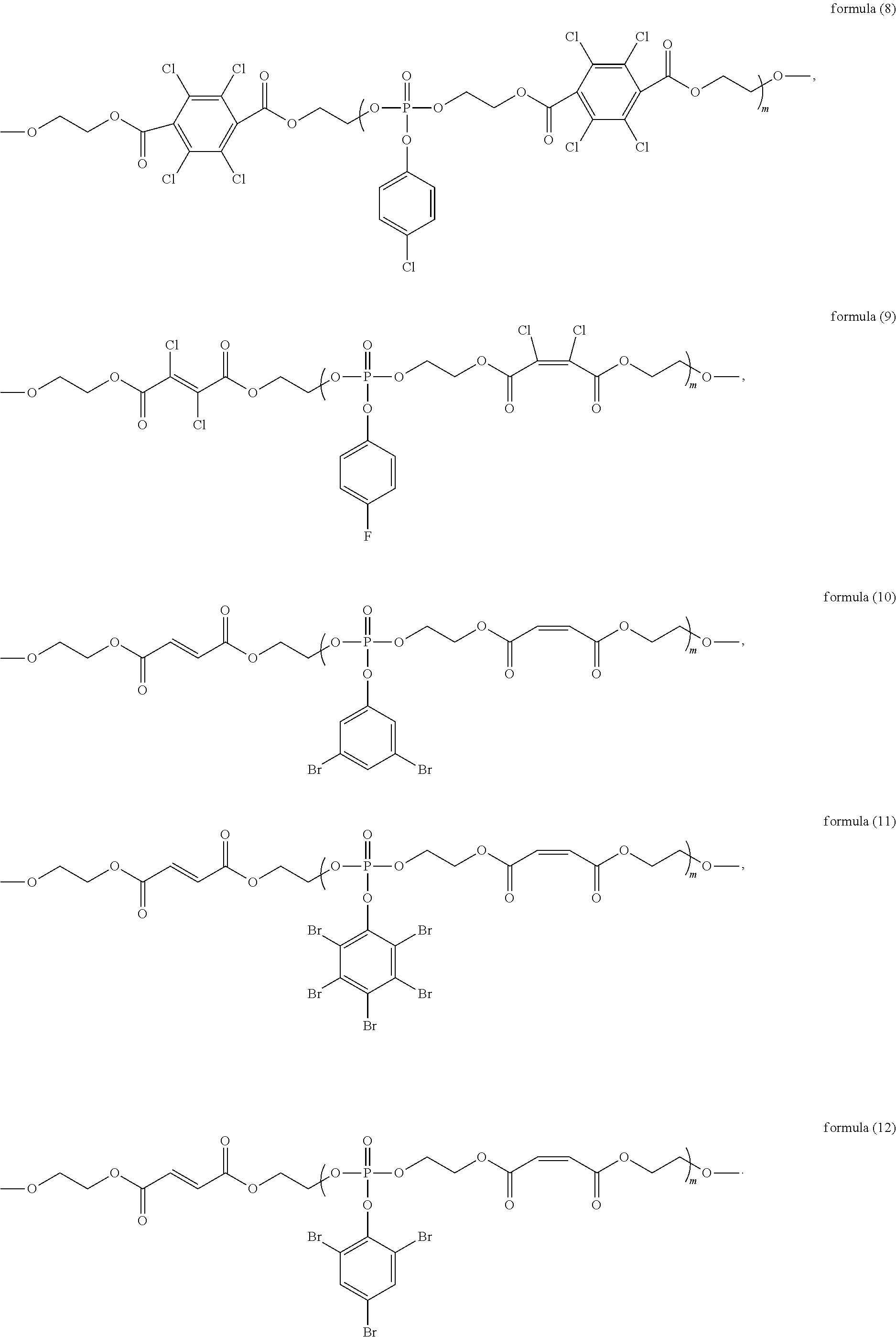

26. The polyol according to any one of claim 19, wherein the halogenated hydroxyl terminated polyphosphoester has a number average molecular weight within a range from 1,000 g/mol to 50,000 g/mol and a hydroxyl value within a range of 2.5-115 mg KOH/g.

27. A halogenated polyphosphonic polyurea elastomer composition comprising component A and component B, wherein component A is prepolymer, the prepolymer comprising a structural unit provided by the halogenated hydroxyl terminated polyphosphoester according to claim 19;
and component B comprises an amino-terminated polyether, an organosilane and a chain extender.

28. The polyurea elastomer composition according to claim 27, wherein the ratio of component A to component B calculated based on the isocyanate index is (1-1.2):1.

29. The polyurea elastomer composition according to claim 27, wherein the amino-terminated polyether is contained in an amount of 18-80 wt. %, the organosilane is contained in an amount of 0.2-2 wt. %, and the chain extender is contained in an amount of 20-35 wt. %, based on the total weight of component B.

30. The polyurea elastomer composition according to claim 27, wherein the prepolymer has a number average molecular weight within a range from 1,500 g/mol to 50,000 g/mol;
wherein the prepolymer is obtained through the pre-polymerization reaction of halogenated hydroxyl terminated polyphosphoester with polyether polyol and isocyanate; wherein the prepolymer has an NCO content within a range of 10-20 wt. %;
wherein the isocyanate is contained in an amount of 20-70 wt. %, the polyether polyol is contained in an amount of 20-70 wt. %, and the halogenated polycarbonate polyol is contained in an amount of 5-20 wt. %, based on the total weight of the prepolymer.

31. The polyurea elastomer composition according to claim 27, wherein a method for preparing the prepolymer comprising:
(D-1) contacting the halogenated hydroxyl terminated polyphosphoester with polyether polyol to carry out a dehydration reaction to obtain an intermediate product;
(D-2) contacting the intermediate product with isocyanate to perform a pre-polymerization reaction to obtain a prepolymer.

32. The polyurea elastomer composition according to claim 31, wherein the dehydration reaction conditions comprise a temperature within the range of 60-120° C., and a time within the range of 0.5-1.5 h;
wherein the pre-polymerization reaction conditions comprise a temperature within the range of 40-90° C., and a time within the range of 1-3h;
wherein the isocyanate is used in an amount of 20-70 wt. %, the polyether polyol is used in an amount of 20-70 wt. %, and the halogenated hydroxyl terminated polyphosphoester is used in an amount of 5-20 wt. %, based on the total weight of the prepolymer.

33. A polyurea elastomer, wherein the polyurea elastomer has an oxygen index larger than or equal to 23%, a tensile strength larger than or equal to 18 MPa, and an elongation at break larger than or equal to 200%.

34. A preparation method of a polyurea elastomer having an oxygen index larger than or equal to 23%, a tensile strength larger than or equal to 18 MPa, and an elongation at break larger than or equal to 200%, the method comprising the following steps:
(1) contacting the halogenated hydroxyl terminated polyphosphoester of claim 21, polyether polyol and an optional diluent with isocyanate to perform a pre-polymerization reaction to obtain component A;
(2) contacting the component A and a component B according to an isocyanate index of (1-1.2):1 to carry out a polymerization reaction, wherein the component B comprises an amino-terminated polyether, an organosilane and a chain extender.

35. The preparation method according to claim 34, wherein the isocyanate is used in an amount of 20-70 wt. %, the polyether polyol is used in an amount of 20-70 wt. %, the halogenated polycarbonate polyol is used in an amount of 5-20 wt. %, and the diluent is used in an amount of 0-15 wt. %, based on the total weight of component A.

36. The preparation method according to claim 34, wherein the component A has an NCO content within a range of 10-20 wt. %,
wherein component A has a number average molecular weight within a range from 1,000 to 50,000.

37. The preparation method according to claim 34, wherein the pre-polymerization reaction conditions in step (1) comprise a temperature within the range of 40-90° C., and a time within the range of 1-3h;
the polymerization conditions in step (2) comprise a temperature within the range of 60-75° C., the contacting is carried out by spraying with a two-component spray gun.

38. A waterproofing, structural reinforcement, or damping and shock absorption of buildings comprising the polyurea elastomer according to claim 33.
